(19) United States
(12) Patent Application Publication
(10) Pub. No.: US 2026/0371250 A1
(43) Pub. Date: Nov. 19, 2026

(54) UPLINK WAKE-UP SIGNAL CONFIGURATIONS

(71) Applicant: QUALCOMM Incorporated, San Diego, CA (US)

(72) Inventor: Hung Dinh LY, San Diego, CA (US)

(21) Appl. No.: 19/206,639

(22) Filed: May 13, 2025

(51) Int. Cl. H04W 52/02; H04L 27/26; H04W 72/0446; H04W 74/0833

(52) U.S. Cl. CPC H04W 52/0235; H04L 27/2666; H04W 72/0446; H04W 74/0833

(57) ABSTRACT

Various aspects of the present disclosure generally relate to wireless communication. In some aspects, a user equipment (UE) may receive, from a network node, a synchronization signal (SS) and physical broadcast channel (PBCH) block (SSB). The UE may receive, from the network node, a configuration message including a physical random access channel (PRACH) configuration associated with the PBCH of the SSB. The UE may transmit, to the network node, a PRACH as an uplink wake up signal (UL WUS) that includes a request for a system information block (SIB), wherein the PRACH is transmitted based on the PRACH configuration. Numerous other aspects are described.

### FIELD OF THE DISCLOSURE

Aspects of the present disclosure generally relate to wireless communication and specifically relate to techniques, apparatuses, and methods associated with uplink wake-up signal configurations.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In a wireless network, a variety of signaling and configuration protocols are utilized to manage network resources and ensure efficient communication between a user equipment (UE) and network nodes. In some examples, system information blocks (SIBs) may be utilized to provide parameters and configurations to UEs, enabling them to access network services and perform various communication tasks. For example, a first SIB (denoted as SIB1) may include information for the initial access and connection setup of UEs.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to receive, from a network node, a synchronization signal (SS) and physical broadcast channel (PBCH) block (SSB). The processing system may be configured to cause the UE to receive, from the network node, a configuration message including a physical random access channel (PRACH) configuration associated with the PBCH of the SSB. The processing system may be configured to cause the UE to transmit, to the network node, a PRACH as an uplink wake up signal (UL WUS) that includes a request for a system information block (SIB), wherein the PRACH is transmitted based on the PRACH configuration.

Some aspects described herein relate to a network node. The network node may include a processing system. The processing system may include one or more processors and one or more code-storing memories coupled with the one or more processors. The processing system may be configured to cause the network node to transmit, to a UE, an SSB. The processing system may be configured to cause the network node to transmit, to the UE, a configuration message including a PRACH configuration associated with the PBCH of the SSB. The processing system may be configured to cause the network node to receive, from the UE, a PRACH as a UL WUS that includes a request for a SIB.

Some aspects described herein relate to a method for wireless communication performed by a UE. The method may include receiving, from a network node, an SSB. The method may include receiving, from the network node, a configuration message including a PRACH configuration associated with the PBCH of the SSB. The method may include transmitting, to the network node, a PRACH as a UL WUS that includes a request for a SIB, wherein the PRACH is transmitted based on the PRACH configuration.

Some aspects described herein relate to a method of wireless communication performed by a network node. The method may include transmitting, to a UE, an SSB. The method may include transmitting, to the UE, a configuration message including a

PRACH configuration associated with the PBCH of the SSB. The method may include receiving, from the UE, a PRACH as a UL WUS that includes a request for a SIB.

Some aspects described herein relate to a non-transitory computer-readable medium that stores a set of instructions for wireless communication by a UE. The set of instructions, when executed by one or more processors of the UE, may cause the UE to receive, from a network node, an SSB. The set of instructions, when executed by one or more processors of the UE, may cause the UE to receive, from the network node, a configuration message including a PRACH configuration associated with the PBCH of the SSB. The set of instructions, when executed by one or more processors of the UE, may cause the UE to transmit, to the network node, a PRACH as a UL WUS that includes a request for a SIB, wherein the PRACH is transmitted based on the PRACH configuration.

Some aspects described herein relate to a non-transitory computer-readable medium that stores a set of instructions for wireless communication by a network node. The set of instructions, when executed by one or more processors of the network node, may cause the network node to transmit, to a UE, an SSB. The set of instructions, when executed by one or more processors of the network node, may cause the network node to transmit, to the UE, a configuration message including a PRACH configuration associated with the PBCH of the SSB. The set of instructions, when executed by one or more processors of the network node, may cause the network node to receive, from the UE, a PRACH as a UL WUS that includes a request for a SIB.

Some aspects described herein relate to an apparatus for wireless communication. The apparatus may include means for receiving, from a network node, an SSB. The apparatus may include means for receiving, from the network node, a configuration message including a PRACH configuration associated with the PBCH of the SSB. The apparatus may include means for transmitting, to the network node, a PRACH as a UL WUS that includes a request for a SIB, wherein the PRACH is transmitted based on the PRACH configuration.

Some aspects described herein relate to an apparatus for wireless communication. The apparatus may include means for transmitting, to a UE, an SSB. The apparatus may include means for transmitting, to the UE, a configuration message including a PRACH configuration associated with the PBCH of the SSB. The apparatus may include means for receiving, from the UE, a PRACH as a UL WUS that includes a request for a SIB.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of a frame structure in a wireless communication network.

FIG. 3 is a diagram illustrating an example of a slot format.

FIG. 4 is a diagram illustrating an example of physical channels and reference signals in a wireless network.

FIG. 5 is a diagram illustrating an example of a synchronization signal hierarchy.

FIG. 6 is a diagram illustrating an example of a low-power wakeup radio and a low-power wakeup signal (WUS).

FIGS. 7A-7F are diagrams illustrating an example of on-demand system information block signaling for an idle or inactive user equipment (UE).

FIGS. 8A-8B are diagrams illustrating an example associated with uplink WUS configurations.

FIG. 9 is a diagram illustrating an example process performed, for example, at a UE or an apparatus of a UE.

FIG. 10 is a diagram illustrating an example process performed, for example, at a network node or an apparatus of a network node.

FIGS. 11-12 are diagrams of example apparatuses for wireless communication.

### DETAILED DESCRIPTION

In a wireless network, a user equipment (UE) may request, and a network node may provide, a system information block (SIB) (e.g., a SIB type 1 (SIB1)), which may contain a network-node-specific configuration associated with the UE upon entering the network node's coverage. Accordingly, the UE may utilize the SIB1 to configure radio resource control (RRC) parameters, connect to the wireless network, and maintain up-to-date information about network resources and policies. The process of providing the UE with configuration information that enables the UE to request the SIB1 may include continuous or periodic broadcasting, which can lead to excessive energy consumption at the network side, especially in scenarios where the network seeks to enter energy-saving modes.

For a UE operating in an idle (or inactive) state, a network energy saving (NES) network node (or cell) may rely on another network node or cell (denoted as a network node A) for providing an uplink (UL) wakeup signal (WUS) configuration to the UE. For example, the UE may utilize a UL WUS to request that the NES network node provide the requested SIB1. Additionally, or alternatively, in some examples, the NES network node may provide the UL WUS configuration to the UE, thereby enabling the UE to request the SIB1 from the NES network node.

However, the configuration parameters that enable the UE to request SIB1, such as uplink transmission parameters, including preamble formats, subcarrier spacings (SCSs), and time and frequency resource configuration, may be associated with a relatively high signaling overhead. Such relatively high overhead may result in degraded performance and increased energy usage.

Various aspects relate generally to optimizing wireless communication systems to enable a UE to access system information with reduced energy consumption and signaling overhead. Some aspects more specifically relate to a UE receiving, from a network node, a synchronization signal (SS) and physical broadcast channel (PBCH) block (SSB), and receiving, from the network node, a configuration message that includes a physical random access channel (PRACH) configuration associated with the PBCH of the SSB. The UE may then transmit a PRACH to the network node, that includes a request for a SIB, where the PRACH is transmitted based on the PRACH configuration.

In some aspects, the PRACH configuration relates to time-domain configurations associated with scheduling of PRACH occasions. In some aspects, the PRACH configuration may indicate a periodicity for PRACH resources based on an SSB periodicity associated with an initial cell selection for the UE or associated with a PRACH occasion validation associated with the request for the SIB. For example, the periodicity for PRACH resources may be an SSB periodicity that is active at the initial cell selection for the UE. Additionally, in some aspects, the PRACH may be transmitted in one or more PRACH occasions determined by an offset applied to a reference frequency indicated by the PRACH configuration.

Particular aspects of the subject matter described in this disclosure can be implemented to realize one or more of the following potential advantages. In some examples, the UE can utilize the PRACH configuration to request system information (e.g., SIB1) with increased efficiency, including a reduced signaling load. As a result, the UE may conserve processing and network resources, and may increase spectral efficiency. Furthermore, the UE's ability to adapt sub-carrier spacing (e.g., as indicated by a master information block (MIB)) to match the PRACH format associated with the PRACH configuration may increase the efficiency of resource utilization. As a result, the UE may reduce power consumption and conserve processing resources by minimizing unnecessary frequency usage and reducing excessive energy usage (e.g., resulting from inappropriate format selection).

Additionally, the system's use of a single bit to indicate the generation of PRACH preambles based on restricted or unrestricted configurations may conserve memory resources and reduce signaling overhead. As a result, such a signaling technique may improve the efficiency of the SIB1 request process while retaining flexibility or robustness in the transmissions between the UE and the network node. In some aspects, the use of a reference frequency and one or more offsets for frequency-domain resource configurations may enable the UE to determine one or more frequency locations for PRACH occasions with minimal signaling, thereby conserving processing and network resources and reducing signaling complexity.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, NES, low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

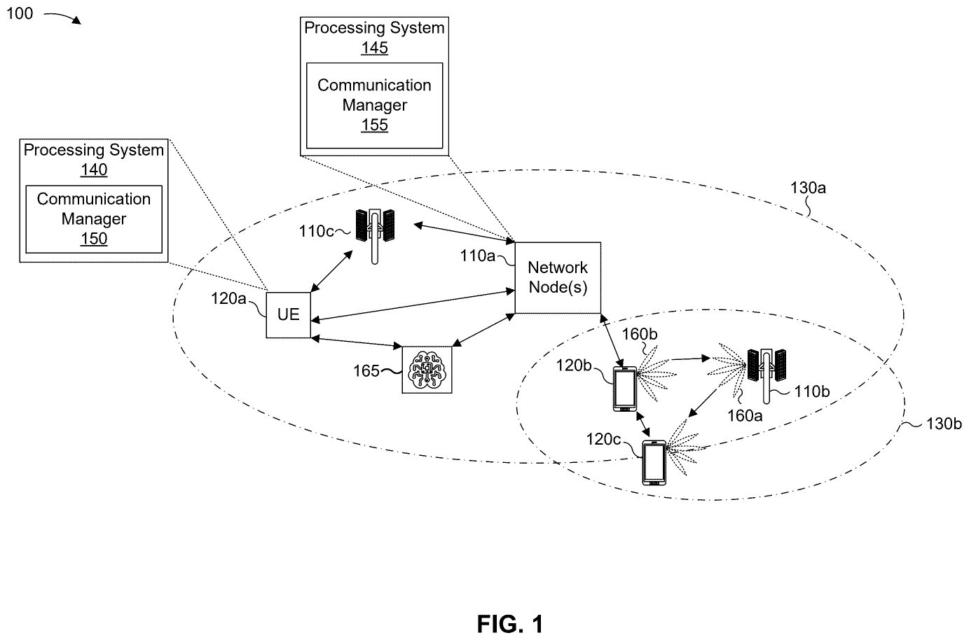

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a, a network node 110b, and a network node 110c (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a RRC layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. DL and UL resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both a UL BWP and a DL BWP (which may be the same or different). Each BWP may be associated with its own numerology (indicating an SCS and cyclic prefix (CP)). A BWP may be dynamically configured or activated (for example, by a network node 110 transmitting a DL control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a DL signal may be or include a reference signal, control information, or data. For example, DL reference signals include a primary synchronization signal (PSS), a secondary SS (SSS), an SS block (SSB) (for example, that includes a PSS, an SSS, and a PBCH), a demodulation reference signal (DMRS), a phase tracking reference signal (PTRS), a tracking reference signal (TRS), and a channel state information (CSI) reference signal (CSI-RS), among other examples. A DL signal carrying control information or data may be transmitted via a DL channel. DL channels may include one or more control channels for transmitting control information and one or more data channels for transmitting data. DL reference signals may be transmitted in addition to, or multiplexed with, DL control channel communications or DL data channel communications. A DL control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of DL or UL grants, slot format indicators (SFIs), preemption indicators (PIs), transmit power control (TPC) commands, hybrid automatic repeat request (HARQ) information, new data indicators (NDIs), among other examples. A DL data channel may be used to transmit DL data (for example, user data associated with a UE 120) from a network node 110 to a UE 120. DL control channels may include physical DL control channels (PDCCHs), and DL data channels may include physical DL shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, a UL signal may include a reference signal, control information, or data. For example, UL reference signals include a sounding reference signal (SRS), a PTRS, and a DMRS, among other examples. A UL signal carrying control information or data may be transmitted via a UL channel. A UL channel may include one or more control channels for transmitting control information and one or more data channels for transmitting data. UL reference signals may be transmitted in addition to, or multiplexed with, UL control channel communications or UL data channel communications. A UL control channel may be specifically used to transmit UL control information (UCI) from a UE 120 to a network node 110. A UL data channel may be used to transmit UL data (for example, user data associated with a UE 120) from a UE 120 to a network node 110. UL control channels may include physical UL control channels (PUCCHs), and UL data channels may include physical UL shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), UL power control information (for example, a UL TPC parameter), or CSI, among other examples. CSI can include a channel quality indicator (CQI) (indicative of DL channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)—reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a DL signal or a UL signal. For example, the network node 110 may select an MCS for a DL signal in accordance with UCI received from the UE 120 or may transmit, to the UE 120, an indication of an MCS to be applied for a UL signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for DL or UL transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more DL or UL signal measurements. The network node 110a or the UE 120a may transmit the processed DL or UL signals, respectively, via one or more antennas.

The network node 110a or the UE 120a may receive UL signals or DL signals, respectively, via one or more antennas. The network node 110a or the UE 120a (for example, using the processing system 145 or the processing system 140, respectively, or one or more coupled modems) may perform signal processing (for example, in accordance with the MCS) on the received UL or DL signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the DL or UL signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the DL or UL signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive, from a network node 110, an SSB; receive, from the network node 110, a configuration message including a PRACH configuration associated with the PBCH of the SSB; and transmit, to the network node 110, a PRACH as a UL WUS that includes a request for a SIB, wherein the PRACH is transmitted based on the PRACH configuration. Additionally, or alternatively, the communication manager 150 may perform one or more other operations described herein.

In some aspects, the network node 110 may include a communication manager 155. As described in more detail elsewhere herein, the communication manager 155 may transmit, to a UE 120, an SSB; transmit, to the UE 120, a configuration message including a PRACH configuration associated with the PBCH of the SSB; and receive, from the UE 120, a PRACH as a UL WUS that includes a request for a SIB. Additionally, or alternatively, the communication manager 155 may perform one or more other operations described herein.

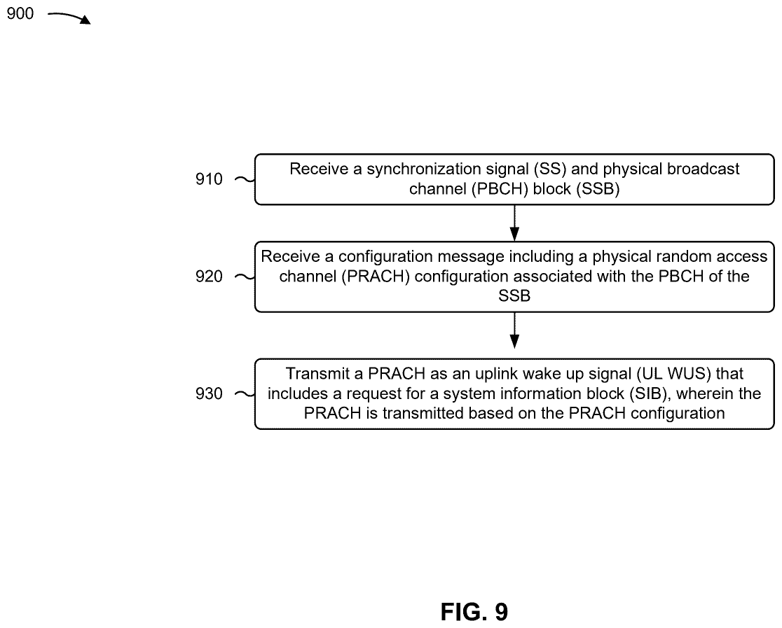

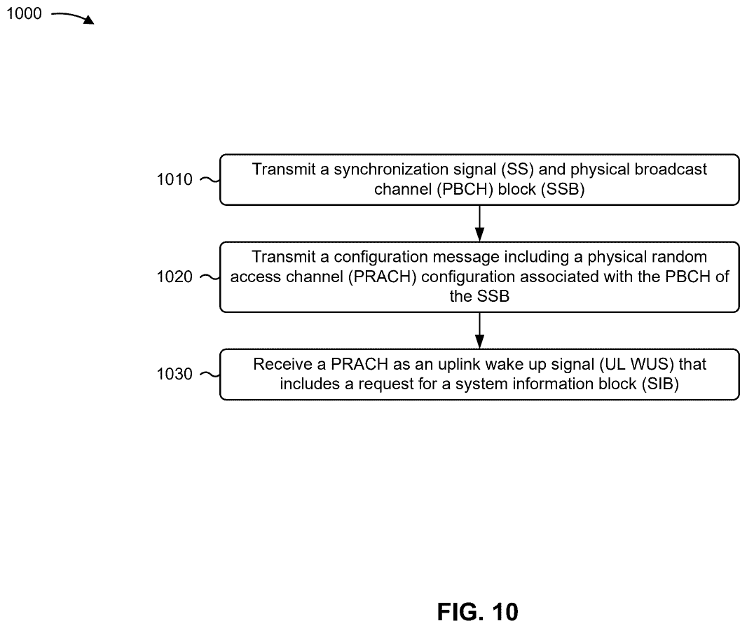

The network node 110, the processing system 145 of the network node 110, the UE 120, the processing system 140 of the UE 120, or any other component(s) of FIG. 1 may implement one or more techniques or perform one or more operations associated with UL WUS configuration, as described in more detail elsewhere herein. For example, the processing system 145 of the network node 110, or the processing system 140 of the UE 120 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 900 of FIG. 9, process 1000 of FIG. 10, or other processes as described herein. In some examples, executing instructions may include running the instructions, converting the instructions, compiling the instructions, or interpreting the instructions, among other examples.

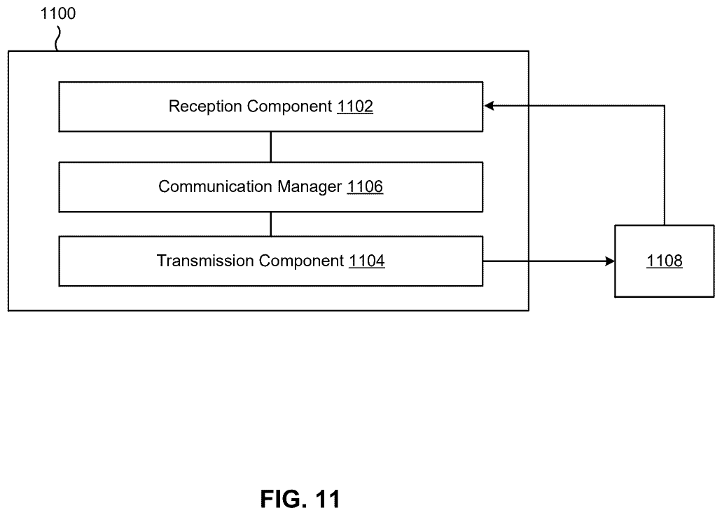

In some aspects, the UE 120 includes means for receiving, from a network node 110, an SSB; means for receiving, from the network node 110, a configuration message including a PRACH configuration associated with the PBCH of the SSB; or means for transmitting, to the network node 110, a PRACH as a UL WUS that includes a request for a SIB, wherein the PRACH is transmitted based on the PRACH configuration. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

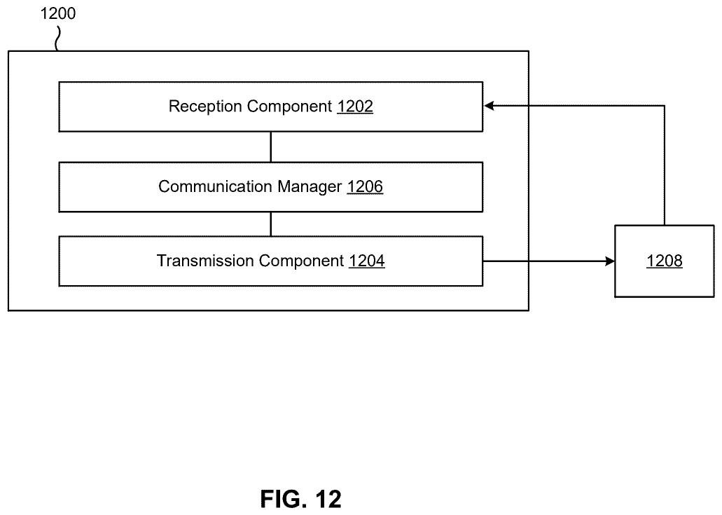

In some aspects, the network node 110 includes means for transmitting, to a UE 120, an SSB; means for transmitting, to the UE 120, a configuration message including a PRACH configuration associated with the PBCH of the SSB; or means for receiving, from the UE 120, a PRACH as a UL WUS that includes a request for a SIB. The means for the network node 110 to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

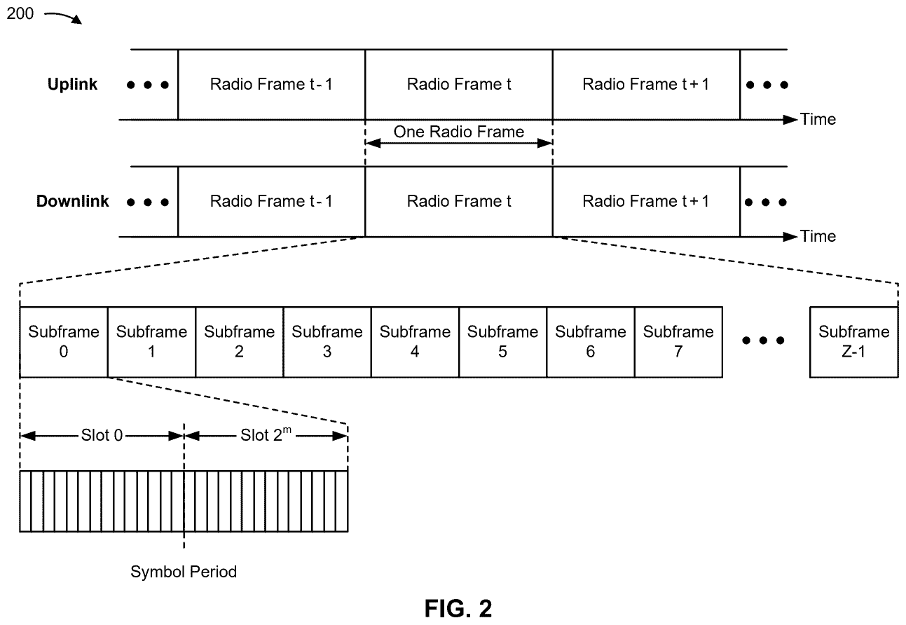

FIG. 2 is a diagram illustrating an example 200 of a frame structure in a wireless communication network. The frame structure shown in FIG. 2 is for frequency division duplexing (FDD) in a telecommunication system, such as LTE or NR. The transmission timeline for each of the DL and UL may be partitioned into units of radio frames (sometimes referred to as frames). Each radio frame may have a predetermined duration (e.g., 10 milliseconds (ms)) and may be partitioned into a set of Z (Z≥1) subframes (e.g., with indices of 0 through Z−1). Each subframe may have a predetermined duration (e.g., 1 ms) and may include a set of slots (e.g., 2 m slots per subframe are shown in FIG. 2, where m is an index of a numerology used for a transmission, such as 0, 1, 2, 3, 4, or another number). Each slot may include a set of L symbol periods. For example, each slot may include fourteen symbol periods (e.g., as shown in FIG. 2), seven symbol periods, or another number of symbol periods. In a case where the subframe includes two slots (e.g., when m=1), the subframe may include 2L symbol periods, where the 2L symbol periods in each subframe may be assigned indices of 0 through 2L-1. In some examples, a scheduling unit for the FDD may be frame-based, subframe-based, slot-based, mini-slot based, or symbol-based. In some examples, a frequency-domain PRACH configuration may determine frequency locations of PRACH occasions within a UL frequency band. For FDD systems, the initial UL BWP may be configured to enable the UE to determine these frequency locations associated with PRACH occasions.

As indicated above, FIG. 2 is provided as an example. Other examples may differ from what is described with respect to FIG. 2.

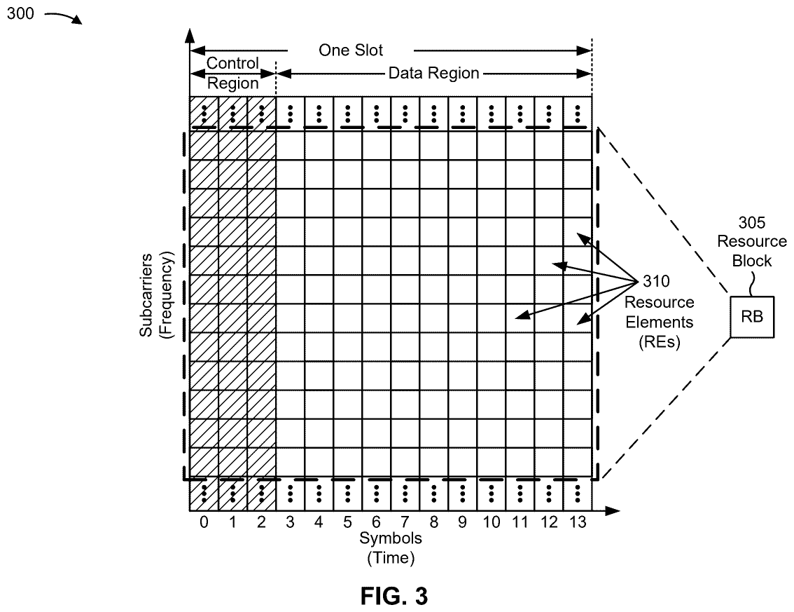

FIG. 3 is a diagram illustrating an example 300 of a slot format. As shown in FIG. 3, time-frequency resources in a radio access network may be partitioned into resource blocks, shown by a single RB 305. An RB 305 is sometimes referred to as a physical resource block (PRB). An RB 305 includes a set of subcarriers (e.g., 12 subcarriers) and a set of symbols (e.g., 14 symbols) that are schedulable by a network node 110 as a unit. In some examples, an RB 305 may include a set of subcarriers in a single slot. As shown, a single time-frequency resource included in an RB 305 may be referred to as a resource element (RE) 310. An RE 310 may include a single subcarrier (e.g., in frequency) and a single symbol (e.g., in time). A symbol may be referred to as an orthogonal frequency division multiplexing (OFDM) symbol. An RE 310 may be used to transmit one modulated symbol, which may be a real value or a complex value. In the context of UL WUS configurations, the time-domain structure may be associated with determining a scheduling and an allocation of PRACH resources for transmissions from a UE to a network node.

In some telecommunication systems (e.g., NR), RBs 305 may span 12 subcarriers with an SCS of, for example, 15 kilohertz (kHz), 30 kHz, 60 kHz, or 120 kHz, among other examples, over a 0.1 millisecond (ms) duration. A radio frame may include 40 slots and may have a length of 10 ms. Consequently, each slot may have a length of 0.25 ms. However, a slot length may vary depending on a numerology used to communicate (e.g., an SCS or a cyclic prefix format). A slot may be configured with a link direction (e.g., DL or UL) for transmission. In some examples, the link direction for a slot may be dynamically configured.

As indicated above, FIG. 3 is provided as an example. Other examples may differ from what is described with respect to FIG. 3.

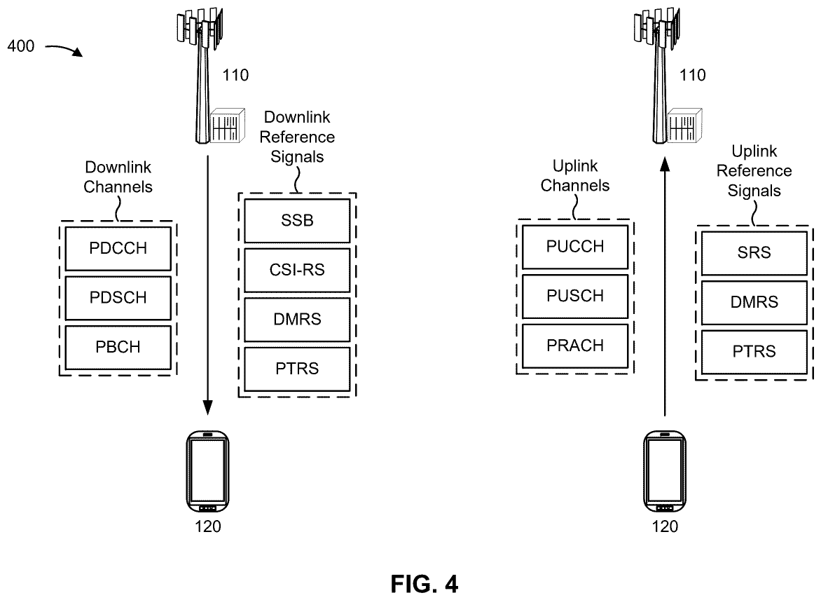

FIG. 4 is a diagram illustrating an example 400 of physical channels and reference signals in a wireless network. As shown in FIG. 4, DL channels and DL reference signals may carry information from a network node 110 to a UE 120, and UL channels and UL reference signals may carry information from a UE 120 to a network node 110.

As shown, a DL channel may include a PDCCH that carries DCI, a PDSCH that carries DL data, or a PBCH that carries system information, among other examples. In some examples, PDSCH communications may be scheduled by PDCCH communications. As further shown, a UL channel may include a PUCCH that carries UCI, a PUSCH that carries UL data, or a PRACH used for initial network access, among other examples. For example, a PRACH configuration may include parameters such as preamble formats, SCSs, and time and frequency resource allocations, which may be utilized to initiate and maintain network access. For example, the PRACH configuration may be associated with network entry, handovers, or re-establishing connections after a temporary connection loss. In some examples, the UE 120 may transmit ACK or NACK feedback (e.g., ACK/NACK feedback or ACK/NACK information) in UCI on the PUCCH or the PUSCH.

As further shown, a DL reference signal may include an SSB, a CSI-RS, a DMRS, a positioning reference signal (PRS), or a phase tracking reference signal (PTRS), among other examples. As also shown, a UL reference signal may include an SRS, a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some examples, the network node 110 may transmit multiple SSBs on multiple corresponding beams, and the SSBs may be used for beam selection.

A CSI-RS may carry information used for DL channel estimation (e.g., DL CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a PMI, a CRI, an LI, an RI, or an RSRP, among other examples. The network node 110 may use the CSI report to select transmission parameters for DL communications to the UE 120, such as a number of transmission layers (e.g., a rank), a precoding matrix (e.g., a precoder), an MCS, or a refined DL beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both DL communications and UL communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both DL communications (e.g., on the PDSCH) and UL communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect DL signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some examples, the network node 110 may then calculate a position of the UE 120 based on the RSTD measurements reported by the UE 120.

An SRS may carry information used for UL channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as UL CSI acquisition, DL CSI acquisition for reciprocity-based operations, UL beam management, among other examples. The network node 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

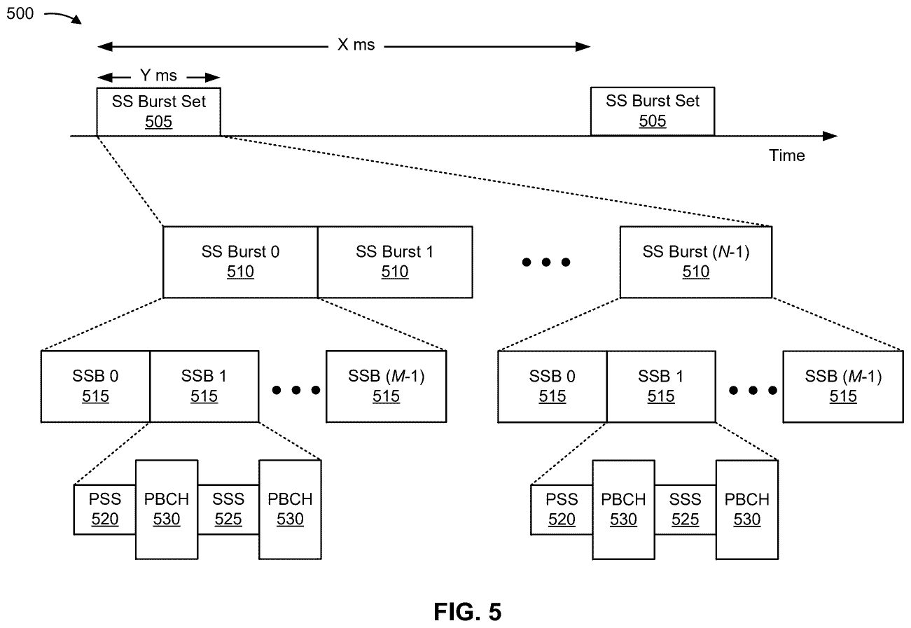

FIG. 5 is a diagram illustrating an example 500 of a synchronization signal (SS) hierarchy. As shown in FIG. 5, the SS hierarchy may include an SS burst set 505, which may include multiple SS bursts 510, shown as SS burst 0 through SS burst N−1, where N is a maximum number of repetitions of the SS burst 510 that may be transmitted by one or more network nodes. As further shown, each SS burst 510 may include one or more SSBs 515, shown as SSB 0 through SSB M−1, where M is a maximum number of SSBs 515 that can be carried by an SS burst 510. In some examples, different SSBs 515 may be beam-formed differently (e.g., transmitted using different beams), and may be used for cell search, cell acquisition, beam management, or beam selection (e.g., as part of an initial network access procedure). An SS burst set 505 may be periodically transmitted by a wireless node (e.g., a network node 110), such as every X milliseconds, as shown in FIG. 5. In some examples, an SS burst set 505 may have a fixed or dynamic length, shown as Y milliseconds in FIG. 5. In some cases, an SS burst set 505 or an SS burst 510 may be referred to as a discovery reference signal (DRS) transmission window or an SSB measurement time configuration (SMTC) window.

In some examples, an SSB 515 may include resources that carry a PSS 520, an SSS 525, or a PBCH 530. In some examples, multiple SSBs 515 are included in an SS burst 510 (e.g., with transmission on different beams), and the PSS 520, the SSS 525, or the PBCH 530 may be the same across each SSB 515 of the SS burst 510. In some examples, a single SSB 515 may be included in an SS burst 510. In some examples, the SSB 515 may be at least four symbols (e.g., OFDM symbols) in length, where each symbol carries one or more of the PSS 520 (e.g., occupying one symbol), the SSS 525 (e.g., occupying one symbol), or the PBCH 530 (e.g., occupying two symbols). In some examples, an SSB 515 may be referred to as an SS/PBCH block.

In some examples, the symbols of an SSB 515 are consecutive, as shown in FIG. 5. In some examples, the symbols of an SSB 515 are non-consecutive. Similarly, In some examples, one or more SSBs 515 of the SS burst 510 may be transmitted in consecutive radio resources (e.g., consecutive symbols) during one or more slots. Additionally, or alternatively, one or more SSBs 515 of the SS burst 510 may be transmitted in non-consecutive radio resources.

In some examples, the SS bursts 510 may have a burst period, and the SSBs 515 of the SS burst 510 may be transmitted by a wireless node (e.g., a network node 110) according to the burst period. In this case, the SSBs 515 may be repeated during each SS burst 510. In some examples, the SS burst set 505 may have a burst set periodicity, whereby the SS bursts 510 of the SS burst set 505 are transmitted by the wireless node according to the fixed burst set periodicity. In other words, the SS bursts 510 may be repeated during each SS burst set 505.

In some examples, an SSB 515 may include an SSB index, which may correspond to a beam used to carry the SSB 515. A UE 120 may monitor for or measure SSBs 515 using different receive (Rx) beams during an initial network access procedure or a cell search procedure, among other examples. Based at least in part on the monitoring or measuring, the UE 120 may indicate one or more SSBs 515 with a best signal parameter (e.g., an RSRP parameter) to a network node 110 (e.g., directly or via one or more other network nodes). The network node 110 and the UE 120 may use the one or more indicated SSBs 515 to select one or more beams to be used for communication between the network node 110 and the UE 120 (e.g., for a random access channel (RACH) procedure). Additionally, or alternatively, the UE 120 may use the SSB 515 or the SSB index to determine a cell timing for a cell via which the SSB 515 is received (e.g., a serving cell).

As indicated above, FIG. 5 is provided as an example. Other examples may differ from what is described with regard to FIG. 5.

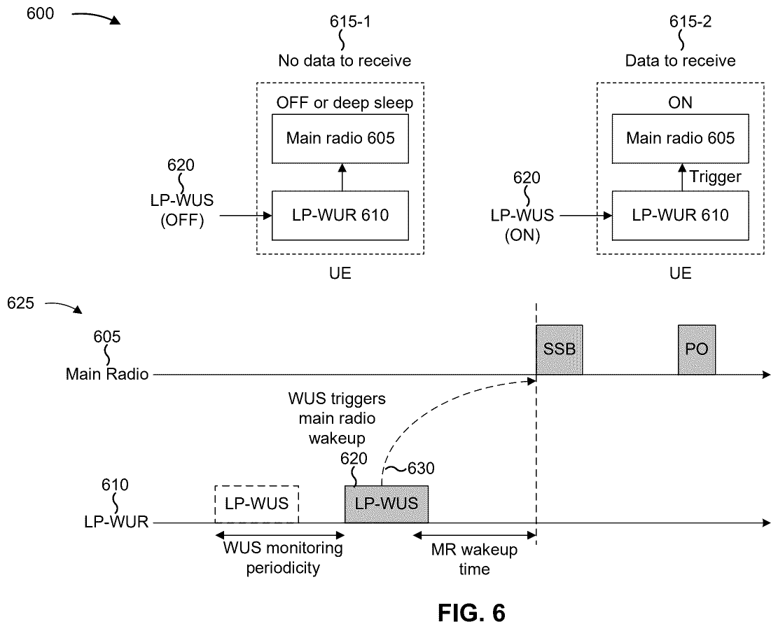

FIG. 6 is a diagram illustrating an example 600 of a low-power wakeup radio (LP-WUR) and a low-power WUS (LP-WUS). As shown in FIG. 6, a UE (such as UE 120) may be equipped with a communication system that includes a main radio (illustrated as “MR”) 605 and an LP-WUR 610 to reduce power consumption and enable low latency. For example, power saving and low latency are often conflicting goals because placing one or more components into a sleep state more often to reduce power consumption also increases latency (e.g., because data cannot be transmitted or received while the one or more components are in the sleep state), and because reducing the time that one or more components spend in a sleep state to reduce latency can lead to increased power consumption. Accordingly, as shown in FIG. 6, the UE may be equipped with the LP-WUR 610, which may be considered a companion receiver that can be used with a main radio 605 to reduce power consumption and latency.

In some examples, the UE may generally use the main radio 605 to transmit or receive user data, and the main radio 605 may be turned off or operated in a deep sleep state unless there is user data to transmit or receive. Furthermore, the LP-WUR 610 may serve as a simple wakeup receiver for the main radio 605, and the LP-WUR 610 may be active and monitoring for an LP-WUS while the main radio 605 is off or in the deep sleep state. For example, reference number 615-1 depicts a first state associated with the main radio 605 and the LP-WUR 610 where there is no user data to be provided to the main radio 605. In such cases, the main radio 605 may be off or operated in the deep sleep state unless there is user data to transmit, and the LP-WUR 610 may monitor for an LP-WUS (for example, continuously, or periodically in monitoring occasions that are separated in time). Furthermore, reference number 615-2 depicts a second state associated with the main radio 605 and the LP-WUR 610 where there is user data for the main radio 605. In such cases, the LP-WUR 610 may receive an LP-WUS 620 (such as from a network node 110) and may provide a trigger to wake or otherwise activate the main radio 605 based on detecting the LP-WUS 620. Accordingly, the main radio 605 may then transmit or receive user data.

In general, the LP-WUR 610 may consume very little power (for example a target power consumption less than 100 microwatts (μW) in the active state), which may be achieved using simple modulation schemes (for example, on-off keying (OOK)), a narrow bandwidth (for example, less than 5 MHz), or other suitable techniques. In this way, the LP-WUR 610 can be used to reduce the time that the main radio 605 spends in an on state or may avoid unnecessarily waking the main radio 605 from the off or deep sleep state when there is no user data to transmit or receive, which tends to be costly from a power consumption perspective. Furthermore, because the LP-WUR 610 has a very low power consumption, the LP-WUR 610 can be used to frequently or continuously perform LP-WUS monitoring, which may improve latency because the main radio 605 can be woken up when there is user data that the main radio 605 needs to receive. For example, the LP-WUR 610 may not suffer from the latency versus power efficiency tradeoff associated with duty cycling schemes. Furthermore, in addition to performing LP-WUS monitoring, which may be used for paging reception, the LP-WUR 610 may monitor a low power synchronization signal (LP-SS) for time and frequency tracking and radio resource management (RRM) measurement. In this way, by monitoring the LP-SS, serving cell or neighbor cell monitoring can be offloaded from the main radio 605 to the LP-WUR 610 to reduce how often the main radio 605 is woken up, which can further reduce power consumption.

In some examples, the LP-WUR 610 may include an OOK WUR (also referred to as an envelope detector (ED) WUR). An OOK WUR may only detect the amplitude (such as the magnitude) of a received signal. A UE that uses an OOK WUR may detect the phase of a received signal by activating the main radio 605.

In some examples, the LP-WUR 610 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

In some examples, as shown by reference number 625, one application of the LP-WUR 610 is to monitor the LP-WUS 620 for paging monitoring, which can be used to reduce unnecessary paging reception performed by the main radio 605. For example, as shown in FIG. 6, the LP-WUR 610 may be configured to monitor for an LP-WUS 620 (while the main radio 605 is off or in a deep sleep state) according to a WUS monitoring periodicity. For example, the LP-WUR 610 may monitor for the LP-WUS 620 in periodic LP-WUS monitoring occasions that are spaced in time according to the WUS monitoring periodicity. Alternatively, although not explicitly shown in FIG. 6, the LP-WUR 610 may be configured to continuously monitor for the LP-WUS 620. In general, a network node may transmit an LP-WUS 620 to a UE only in cases where there is a paging message that needs to be sent to the UE while the UE is in an idle or inactive state (such as an RRC idle or RRC inactive state). In such cases, as shown by reference number 630, the LP-WUR 610 may receive and detect the LP-WUS 620, which may trigger the LP-WUR 610 to wake up the main radio 605. In some examples, the LP-WUS 620 may be a sequence-based WUS, which may include a predefined set of sequences (implemented, for example, using OOK modulation or phase modulation). As shown, the main radio 605 may wake up after a main radio wakeup time, and may then start to monitor one or more SSB transmissions to obtain synchronization with the network node before monitoring and receiving the paging message in a subsequent PO. Otherwise, in cases where the LP-WUR 610 does not detect the LP-WUS 620, the main radio 605 may remain in the deep sleep state to save power.

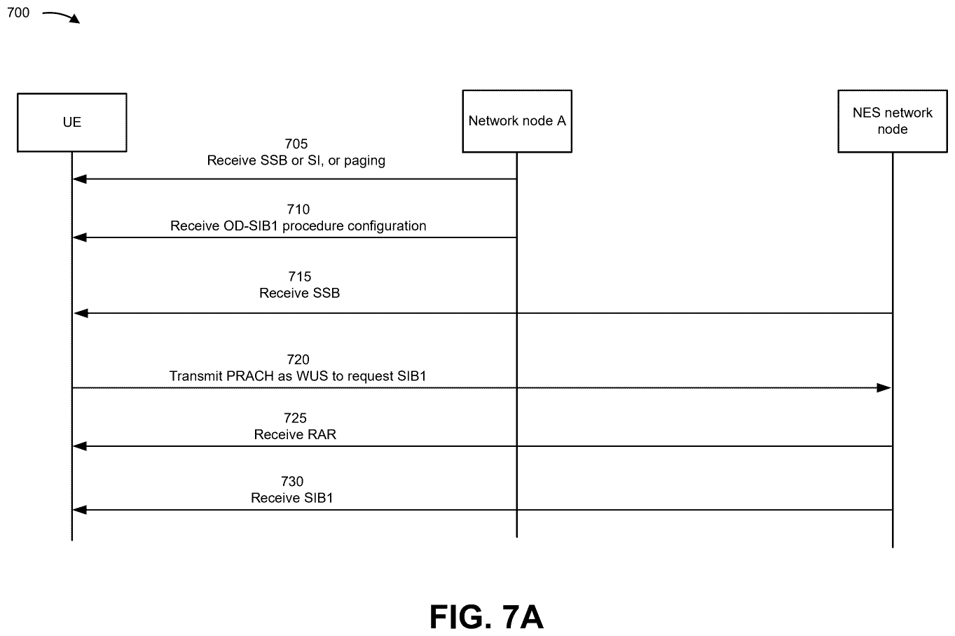

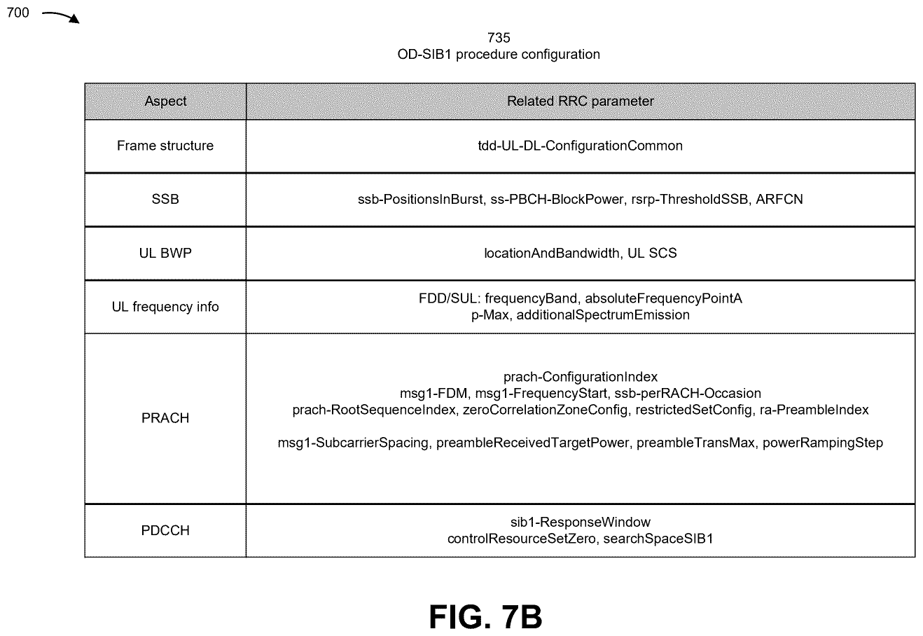

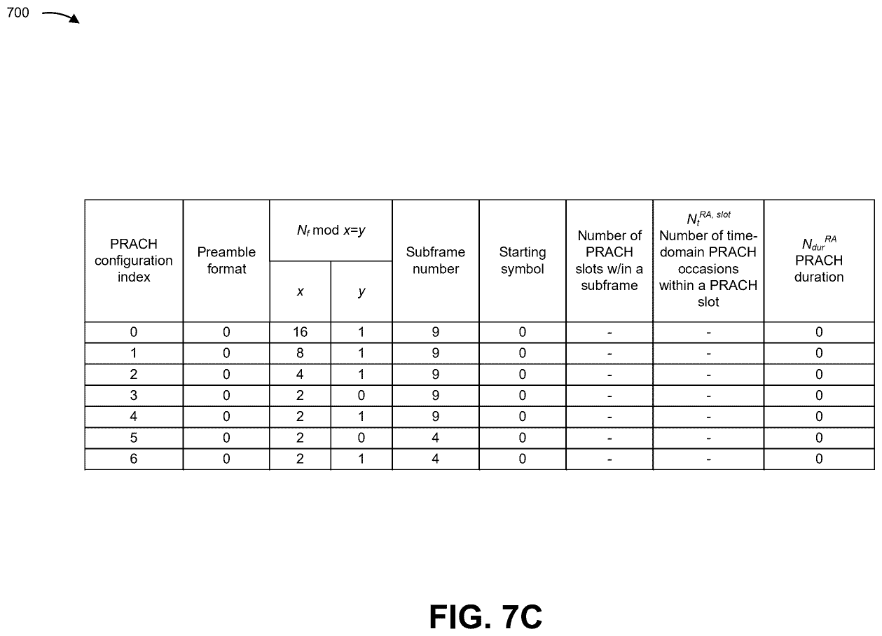

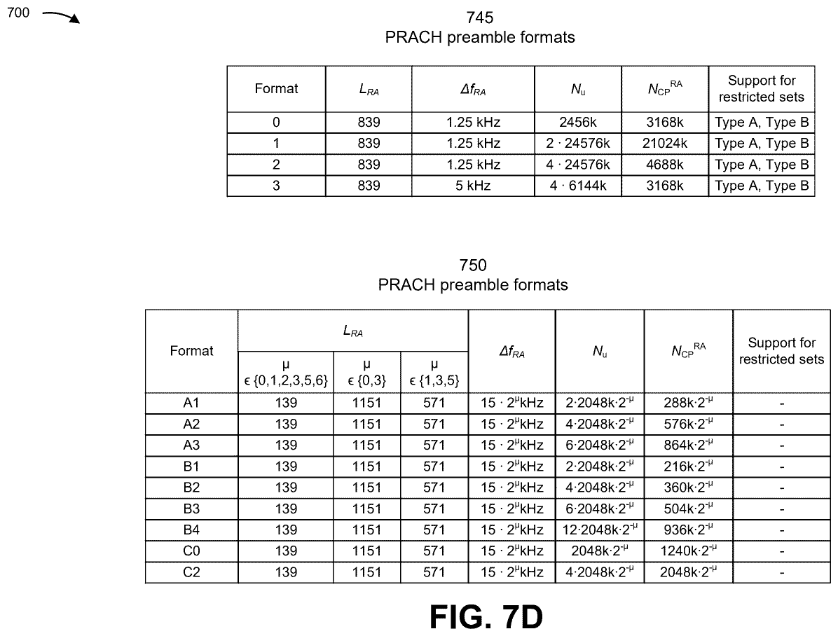

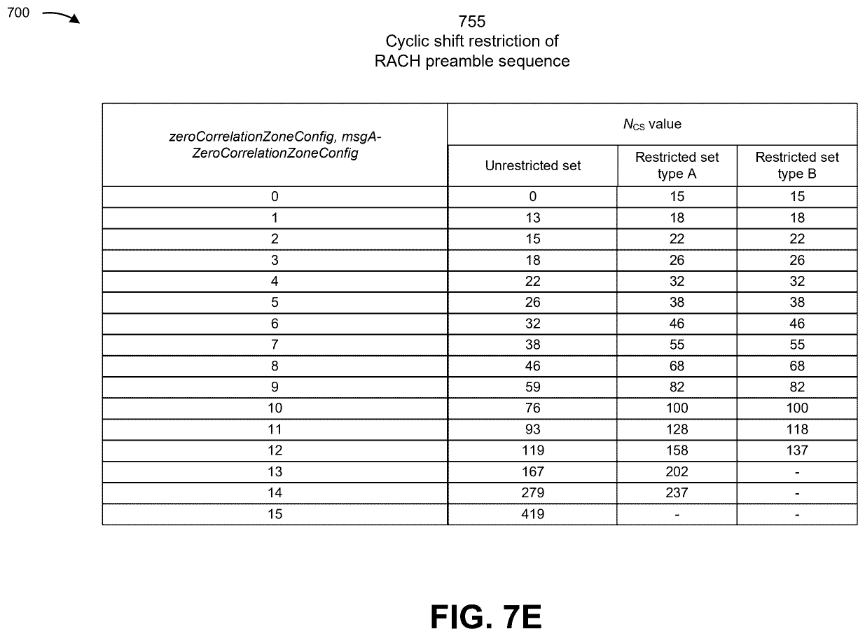

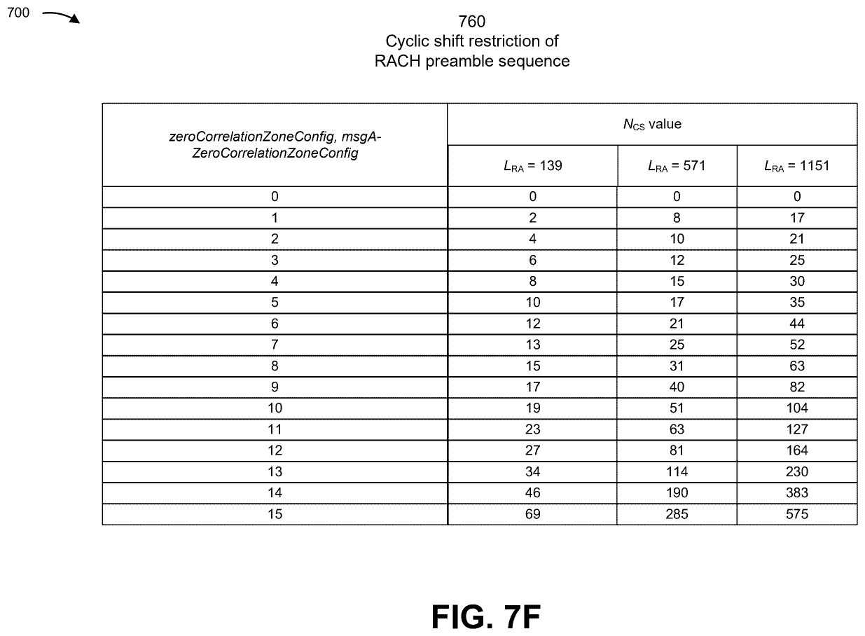

FIGS. 7A-7F are diagrams illustrating an example 700 of on-demand (OD) SIB signaling for an idle or inactive UE, in accordance with the present disclosure. As shown in FIG. 7A, multiple network nodes (e.g., network node 110a or network node 110c) may communicate with a UE (e.g., UE 120). The multiple network nodes may include one or more network nodes 110, one or more CUs, one or more DUs, one or more RUs, one or more core network nodes, one or more network servers, one or more application servers, or one or more Access and Mobility Management Functions (AMFs), among other examples. In some examples, the UE, a first network node (denoted as a “network node A”), and a second network node (denoted as an “NES network node”) may be part of a wireless network (e.g., wireless network 100).

As shown in FIG. 7A, and reference number 705, the network node A may transmit, and the UE may receive, an SSB, system information (SI), or a paging message. For example, the UE may receive the SSB, SI, or paging message from the network node A. The SSB may include synchronization signals, while the SI or paging message may provide system information or indicate incoming communications, respectively. Additionally, or alternatively, the UE may receive an SS or a broadcast message (BM) from the network node A. For example, the SS may provide synchronization information, and the BM may deliver broadcast information necessary for the UE's operation.

As shown by reference number 710, the network node A may transmit, and the UE may receive, an OD-SIB1 procedure configuration. For example, the OD-SIB1 procedure configuration may be received from the network node A and may include parameters enabling the UE to request a SIB1 (e.g., on-demand). As shown by reference number 715, the NES network node may transmit, and the UE may receive, an additional SSB. For example, the additional SSB may provide synchronization and broadcast information for subsequent communications with the NES network node. Additionally, or alternatively, the UE may receive multiple SSBs or SI messages that provide synchronization and broadcast information. These multiple SSB or SI messages may provide the UE with one or more parameters for reliable communication with the NES network node.

As shown by reference number 720, the UE may transmit, and the NES network node may receive, a PRACH as a UL WUS to request SIB1. For example, the UE may use the PRACH to transmit a wake-up signal that includes a request for SIB1 based on the received OD-SIB1 procedure configuration. As shown by reference number 725, the NES network node may transmit, and the UE may receive, an RAR message. For example, the RAR message may be received from the NES network node and include information acknowledging the PRACH and providing further instructions for the UE. Additionally, or alternatively, the RAR message may include timing advance information and further scheduling details, and the UE may utilize such information or details in subsequent communications with the NES network node.

As shown by reference number 730, the NES network node may transmit, and the UE may receive, the SIB1. For example, the received SIB1 may include cell-specific configurations and system information for the UE to access or communicate with one or more network nodes. Additionally, or alternatively, the SIB1 may include parameters for initial cell selection and handover procedures.

As shown in FIG. 7B, and by reference number 735, the UE may receive an OD-SIB1 procedure configuration. In some examples, the OD-SIB1 procedure configuration may include one or more parameters related to an OD-SIB1 procedure configuration that the UE may utilize to request SIB1 (e.g., via a PRACH as a UL WUS). For example, the OD-SIB1 procedure configuration may include aspects or parameters related to frame structure, which may indicate positioning of SSBs within a frame.

In some examples, the OD-SIB1 procedure configuration may include SSB positions. For example, the SSB positions may be indicated to enable the UE to effectively synchronize with the network. Additionally, or alternatively, the OD-SIB1 procedure configuration may include a UL BWP location. For example, the OD-SIB1 procedure configuration may indicate a frequency range and bandwidth allocation for the UL BWP. In some examples, the OD-SIB1 procedure configuration may indicate frequency domain configurations (e.g., UL frequency info), which may include a frequency range and SCS for UL transmissions. Additionally, or alternatively, the initial UL BWP can be configured for the UE to determine one or more frequency locations related to PRACH occasions (e.g., in an FDD or an unpaired system). For TDD (e.g., paired) systems, the initial UL BWP can be the same as an initial DL BWP if the initial UL BWP is not explicitly configured. For example, the same frequency resources can be used for both UL and DL transmissions, thereby potentially eliminating the usage of separate configurations. In some examples, one or more parameters may be used to determine the UL BWP, including the frequency location of a first point (e.g., point A, which may be represented as absoluteFrequencyPointA) and frequency offset from the first point to the first RB of the UL BWP (e.g., depicted as offsetToCarrier). For example, the absoluteFrequencyPointA may serve as a reference point within the frequency spectrum, while the offsetToCarrier may indicate a distance (e.g., an offset) from the absoluteFrequencyPointA to the starting RB of the UL BWP. Together, the absoluteFrequencyPointA and offsetToCarrier parameters may enable the UE to accurately locate the UL BWP within the UL frequency band, thereby increasing the probability that PRACH transmissions are correctly aligned with the network's frequency resources.

Additionally, or alternatively, the OD-SIB1 procedure configuration may include a PRACH configuration. For example, the PRACH configuration may indicate a timing and frequency of PRACH occasions. In some examples, the OD-SIB1 procedure configuration may indicate a preamble format for PRACH, including options for long preamble formats or short preamble formats. For example, the OD-SIB1 procedure configuration may indicate whether the UE should use a long preamble format (e.g., for enhanced coverage) or a short preamble format (e.g., for reduced latency). Additionally, or alternatively, the OD-SIB1 procedure configuration may indicate an SCS to be used for PRACH transmissions. In some examples, the OD-SIB1 procedure configuration may indicate cyclic shift restrictions to PRACH preamble sequences. For example, the OD-SIB1 procedure configuration may indicate one or more limitations related to the range of cyclic shifts applied to the PRACH preamble to reduce interference. Additionally, or alternatively, the OD-SIB1 procedure configuration may indicate whether the PRACH preamble is generated based on an unrestricted or restricted configuration.

Additionally, or alternatively, the OD-SIB1 procedure configuration may indicate aspects or parameters related to a PDCCH. For example, the OD-SIB1 procedure configuration may indicate the scheduling and allocation of PDCCH resources to enable communication between the UE and the NES network node.

Furthermore, the OD-SIB1 procedure configuration addresses the frequency-domain aspects by including parameters related to a reference frequency and an absolute frequency point, which may enable the UE to determine one or more frequency locations associated with the PRACH resources within the UL band. The OD-SIB1 procedure configuration may also indicate sub-carrier spacings for PRACH transmissions, with values for long and short PRACH formats. Additionally, the OD-SIB1 procedure configuration may include cyclic shift restrictions for the PRACH preamble sequences, values for parameters associated with maximum transmission power, and a periodicity of PRACH resources based on SSB periodicity. The OD-SIB1 procedure configuration index may indicate whether the PRACH preamble is generated based on an unrestricted or restricted configuration. However, the OD-SIB1 procedure configuration may be associated with a relatively high payload size (e.g., an ssb-PositionsInBurst parameter may include up to 64 bits in FR2). As a result, it may be infeasible to include OD-SIB1 procedure configuration information in a MIB.

As shown by FIG. 7C, and reference number 740, a PRACH configuration may include parameters related to a time-domain resource configuration for transmission of a PRACH as a UL WUS. In some examples, the PRACH configuration may include a PRACH configuration index, an indication of a preamble format, or a periodicity associated with a UL WUS. Additionally, the configuration index may include the subframe number (SFN), a starting symbol, and the number of PRACH slots within a subframe, which may be associated with the timing and allocation of PRACH resources. Additionally, the configuration may indicate a quantity of time-domain PRACH occasions within a PRACH slot and the PRACH duration. In some examples, 8 bits may be utilized to indicate a time domain PRACH configuration (e.g., Prach-ConfigurationIndex). However, in some examples, the quantity of bits may be reduced, where the relative flexibility associated with such a time-domain resource configuration is reduced.

As shown by FIG. 7D, and reference numbers 745 and 750, a PRACH preamble format may enable multiple SCSs, where one or more SCSs may be configured in a SIB1 (E.g., msg1-SubcarrierSpacing). For example, and as shown by reference number 745, a PRACH preamble format may be 0, 1, 2, or 3. As shown by reference number 750, a PRACH preamble format may be A1, A2, A3, B1, B2, B3, B4,C0, or C2. For example, in FR1, the PRACH preamble format may be associated with a long format for an SCS of 1.25 kHz or 5 kHz, or the PRACH preamble format may be associated with a short format for an SCS of 15 kHz or 30 kHz.

As shown by FIGS. 7E and 7F, and by reference numbers 755 and 760, a RACH preamble sequence may be associated with a cyclic shift restriction. In some examples, generation of a RACH preamble may depend on a restricted configuration for a cyclic shift of a RACH sequence for long PRACH formats. For example, a restricted set configuration may include an unrestricted type, a restricted Type A, or a restricted Type B, for long PRACH formats. However, a short PRACH format may be associated with an unrestricted configuration or may exclude a restricted configuration.

As described herein, providing a UE with configuration information associated with SIB requests (e.g., for a UE operating in an idle or inactive states) may be associated with relatively high energy consumption and signaling overhead. Accordingly, where the network node transmits, to the UE, a MIB that includes a PRACH configuration for a UL WUS, the UE may request a SIB while reducing transmission overhead and conserving processing and power resources.

As indicated above, FIGS. 7A-7F are provided as an example. Other examples may differ from what is described with respect to FIGS. 7A-7F.

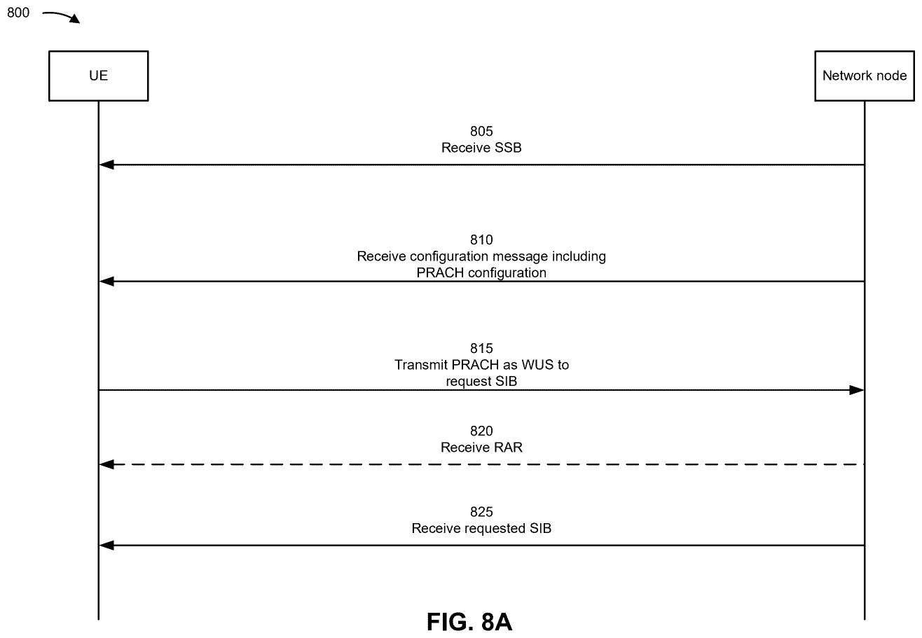

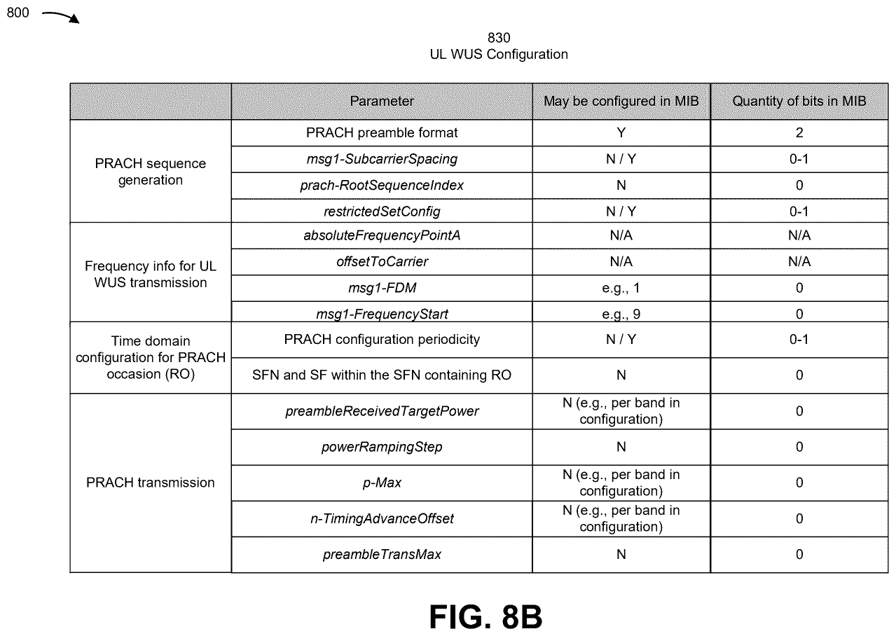

FIGS. 8A-8B are diagrams illustrating an example 800 associated with UL WUS configurations. As shown in FIG. 8A, a network node (e.g., network node 110) and a UE (e.g., UE 120) may communicate with one another.

As shown in FIG. 8A, and by reference number 805, a network node may transmit, and a UE may receive, an SSB. The SSB may include synchronization signals such as a PSS, an SSS, or a PBCH, which may be used for initial network acquisition and synchronization. In some aspects, the PBCH may include a MIB that indicate parameters for transmitting a PRACH as an UL WUS. Additionally, the UE may use these synchronization signals to synchronize the UE's timing and frequency with the network node, enabling continuous communication. Additionally, or alternatively, the network node may broadcast the SSB periodically, where the UE may detect the SSB and utilize the SSB for initial synchronization and network acquisition.

As shown by reference number 810, the network node may transmit, and the UE may receive, a configuration message including a PRACH configuration (e.g., an OD-SIB1 procedure configuration). In some aspects, the PRACH configuration may be associated with the PBCH (e.g. in including the MIB) of the SSB. For example, the PRACH configuration may be received from the network node and may include parameters enabling the UE to request a SIB (e.g., a SIB1) on-demand. The PRACH configuration may include aspects related to frame structure, initial UL BWP location, SCS, and preamble formats for PRACH transmissions. In some aspects, an OD-SIB1 procedure configuration may include parameters enabling the UE to request a SIB1 on demand. For example, the configuration may specify aspects such as frame structure, initial UL BWP location, SCS, or PRACH preamble formats, which may be used by the UE in requesting the SIB1. Additionally, or alternatively, an OD-SIB1 procedure configuration may include obtaining parameters for requesting a SIB1 on-demand. For example, the UE may use these parameters to determine the appropriate PRACH resources and timing for transmitting a SIB1 request.

In some aspects, the PRACH configuration may include parameters for transmitting a UL WUS. In some aspects, the PRACH configuration may include information related to the time-domain and frequency-domain configurations associated with the PRACH resources indicated by the PRACH configuration. For example, the information related to the time-domain and frequency-domain configurations may include information about scheduling of PRACH occasions, SCSs, preamble formats, cyclic shift restrictions, or frequency locations for PRACH occasions. Additionally, or alternatively, the PRACH configuration may indicate whether the PRACH preamble is generated based on a restricted or unrestricted configuration, associated with the cyclic shift of a random access channel sequence.

In some aspects, the MIB (e.g., included in the PBCH) may include details related to time-domain configurations, including configurations related to PRACH occasion scheduling. For example, a time-domain configuration may indicate the scheduling of one or more PRACH occasions in SFNs associated with an odd value or with an even value (e.g., a y value associated with a PRACH configuration). Additionally, the time-domain configuration may include one or more (e.g., two) dedicated bits that indicate a PRACH preamble format (e.g., Format 0, Format 1,Format 2, or Format B4). In some aspects, within the SFN that includes PRACH occasions, these PRACH occasions may be scheduled to occur in specific subframes (e.g., subframes 4 or 9). Additionally, the starting symbol for each PRACH occasion may be configured (e.g., with the PRACH occasions beginning at symbol 0). Such a configured scheduling and symbol allocation enables a structured and predictable framework for PRACH transmissions, while reducing signaling complexity.

Additionally, or alternatively, the MIB may specify frequency-domain configurations such as SCSs and frequency locations for PRACH occasions. For example, the PRACH configuration may indicate a periodicity for one or more PRACH resources associated with the time-domain configuration (e.g., an x value associated with a PRACH configuration). In some aspects, the MIB may indicate the periodicity (e.g., the periodicity may be limited to {80 ms, 160 ms}). Additionally, in some aspects, the periodicity may be an SSB periodicity that the UE assumes for initial cell selection. In some aspects, the periodicity may be an SSB periodicity that the UE assumes for PRACH occasion validation when transmitting a PRACH to request a SIB1. In some aspects, the UE may utilize a periodicity that is different from the SSB periodicity used for initial cell selection or for PRACH occasion validation.

Additionally, or alternatively, the PRACH configuration may specify whether the PRACH preamble is based on a restricted or unrestricted cyclic shift configuration. This may include indicating whether the preamble is generated based on an unrestricted configuration or a restricted configuration, associated with a cyclic shift of a RACH preamble sequence. For example, a RACH preamble may be generated based on one or more cyclic shift restrictions. In some aspects, the RACH preamble may be generated based only on an unrestricted configuration. In some aspects, for a long PRACH format, the RACH preamble generation may be based on either an unrestricted configuration or a restricted configuration. For example, the restricted configuration may be of Type A or Type B, where each type imposes cyclic shift limitations to mitigate interference. For example, a one-bit configuration may be utilized to indicate whether the RACH preamble is generated as an unrestricted configuration or a Type A format. In some aspects, only one restricted configuration, such as Type A, may be utilized for long PRACH formats. Alternatively, for short PRACH formats, the RACH preamble generation may be based on an unrestricted configuration, omitting the need for cyclic shift restrictions and reserving the bit or bits that would otherwise be used to indicate a restricted configuration type. Such an approach enables compatibility with various signaling configurations while reducing overhead.

In some aspects, a frequency-domain PRACH configuration may indicate a reference frequency for determining frequency locations of PRACH occasions. For example, in an FDD system, the reference frequency may be an absolute radio frequency channel number (ARFCN) associated with a smallest channel number in a UL band. This configured reference frequency enables the UE to determine the frequency locations of PRACH occasions within the uplink frequency band. In some aspects, an initial UL BWP may be configured based on the reference frequency and a frequency offset from a designated point (e.g., absoluteFrequencyPointA) to the first RB of the uplink BWP. This configuration reduces the signaling overhead by eliminating extensive frequency location signaling within the MIB. Additionally, or alternatively, the reference frequency may be indicated for each uplink band (e.g., the MIB may indicate one of a plurality of options) in a wireless communications standard (e.g., where an ARFCN is associated with each UL band).

As shown by reference number 815, the UE may transmit, and the network node may receive, a PRACH as an UL WUS that includes a request for a SIB. In some aspects, the PRACH may be transmitted based on the PRACH configuration. For example, the UE may utilize the parameters provided in the received MIB to generate the PRACH based on the PRACH configuration. In some aspects, the PRACH may be transmitted in one or more PRACH occasions determined by an offset applied to a reference frequency indicated by the PRACH configuration. Additionally, the PRACH may be associated with a PRACH preamble format specified by the PRACH configuration, which may include a long format or a short format. In some aspects, the transmission of the PRACH may utilize an SCS configured for DL in the MIB. Alternatively, the PRACH may utilize an SCS of 1.25 kHz based on the PRACH configuration indicating a long PRACH format.

Additionally, or alternatively, the UE may transmit, and the network node may receive, an UL WUS that includes a request for a SIB. In some aspects, the UL WUS may be transmitted based on a configuration message received from the network node, which may include one or more parameters for generating the signal (e.g., waveform) for the UL WUS. For example, the UE may utilize parameters provided in a MIB, which may be configured to adapt to the network node's indicated parameters. The UL WUS may be transmitted in one or more occasions determined by an offset applied to a reference frequency indicated by the configuration message. Additionally, the UL WUS may be related to a preamble format indicated by the configuration, which may include various formats, which may include a long format or a short. For example, a PRACH may be utilized as an UL WUS, or alternatively, one or more different signals may be utilized for the UL WUS. Such different waveforms may be indicated (e.g., for the UE to utilize) based on one or more parameters, including spectral efficiency, power consumption, or compatibility with existing network infrastructure. For example, the transmission of the UL WUS may utilize an SCS configured for DL in the MIB or an SCS indicated by a configuration related to a long format or a short format, as indicated by the network node.

Additionally, or alternatively, the SCS may be indicated in a MIB, where the PRACH configuration may include one or more configured SCSs for PRACH transmissions. For example, interpretation of this MIB indication may depend on whether a short or long PRACH format is selected. In some aspects, for long PRACH formats, the SCS may be set to 1.25 kHz, ensuring consistent and efficient uplink signaling. Conversely, for short PRACH formats, the SCS may align with the DL SCS configured in the MIB (e.g., configured to 15 kHz or 30 kHz). Alternatively, a single bit in the MIB may explicitly indicate the SCS, with interpretation based on the selected PRACH format. For example, a bit value of 0 may correspond to a 1.25 kHz SCS for long PRACH formats, while a bit value of 1 may correspond to a 30 kHz SCS for short PRACH formats. This explicit indication may enable the UE to accurately determine the appropriate SCS for the PRACH based on the format type and the bit value in the MIB, thereby simplifying the configuration process and reducing ambiguity. Alternatively, the MIB may provide an explicit indication for the SCS only when a short PRACH format is selected. For the long PRACH format, the SCS may be 1.25 kHz, and the bit in the MIB is reserved and not used for indication. This approach may simplify the configuration for long PRACH formats while still providing flexibility for short PRACH formats.

In some aspects, the UE may use the received MIB parameters to generate a PRACH for UL WUS. For example, the PRACH preamble format (e.g., including a long format or a short format) may be configured based on the PRACH configuration from the MIB. Additionally, or alternatively, the PRACH may include a request for a SIB. For example, the PRACH may be transmitted during one or more PRACH occasions determined by an offset from a reference frequency indicated in the MIB.

As shown by reference number 820, in some aspects, the network node may transmit, and the UE may receive, a random access response (RAR) message. For example, the RAR message may include information acknowledging the PRACH and providing further instructions for the UE. In some aspects, the RAR message may include timing advance information and additional scheduling details for subsequent communications. For example, the RAR message may indicate how to proceed with the next steps in the communication process. For example, the RAR message may specify the timing and frequency resources that the UE should use for its next transmission.

As shown by reference number 825, the network node may transmit, and the UE may receive, the requested SIB1. For example, the received SIB1 may include cell-specific configurations and system information necessary for the UE to access or communicate with the network node. Additionally, or alternatively, the SIB1 may include parameters for initial cell selection, handover procedures, and other related system information. Additionally, the requested SIB may include be one of a plurality of SIB types available or compatible with the wireless network. For example, the requested SIB may include SIB1 or a subset of additional or alternative SIBs, including SIB2, SIB3, or the like.

As shown by FIG. 8B, and reference number 830, a UL WUS configuration may be configured in a MIB (e.g., in association with a PRACH configuration) to enable a UE to transmit a PRACH to a network node for requesting a SIB1. For example, the UL WUS configuration may include parameters related to the PRACH sequence generation, frequency information for UL WUS transmission, time domain configuration for PRACH occasion, and PRACH transmission. For example, the UL WUS configuration may include parameters related to PRACH sub-carrier spacing, cyclic shift restrictions, and periodicity, thereby enabling the UE or network node to dynamically adjust its operations based on network conditions. Similarly, the UL WUS configuration may include parameters related to a time-domain PRACH configuration that configures PRACH SCS and restricted configuration sets, depending on the conditions. These UL WUS configuration parameters enable the UE or network node to dynamically adjust transmission parameters while efficiently managing the UE's transmission of the PRACH as a UL WUS to request SIB1.

In some aspects, the PRACH sequence generation may include the PRACH preamble format, msg1-SubcarrierSpacing, prach-RootSequenceIndex, and restrictedSetConfig parameters. For example, the network node may provide configurations (e.g., via the MIB) related to the PRACH preamble format, msg1-SubcarrierSpacing, and restrictedSetConfig parameters to enable the UE to transmit a PRACH, to the network node, requesting a SIB1, while conserving overhead resources. For example, the PRACH preamble format may be programmed using 2 bits within the MIB, thereby enabling precise configuration of the preamble format. Similarly, the msg1-SubcarrierSpacing parameter may be configured using 1 bit within the MIB, thereby enabling the SCS to be configured using a relatively reduced overhead. Additionally, the restrictedSetConfig parameter may be included (e.g., utilizing 0-1 bits depending on the configuration) to enable RACH preamble generation based on an unrestricted or restricted configuration.

In some aspects, the frequency information for UL WUS transmission may include absoluteFrequencyPointA, offsetToCarrier, msg1-FDM, and msg1-FrequencyStart parameters. These parameters may be associated with one or more transmission frequencies, enabling the UL WUS transmission to be within the designated frequency bands. In some aspects, the time-domain configuration for PRACH occasion may include PRACH configuration periodicity and the SFN or subframe (SF) within the SFN. For example, the time-domain configuration for PRACH occasion parameters may be configured such that the PRACH occasions are synchronized with the network's operational schedule, thereby simplifying the time-domain configuration and reducing the complexity of synchronization. In some aspects, the PRACH transmission parameters may include preambleReceivedTargetPower, powerRampingStep, p-Max, n-TimingAdvanceOffset, and preambleTransMax. These parameters may be associated with managing the transmission power and timing, thereby enabling efficient and effective communications with the network node.

As described herein, UL WUS configurations may be utilized to enable a UE to access system information with reduced energy consumption and signaling overhead. In some aspects, the UE may receive a message from a network node that includes a MIB associated with a PRACH configuration for a UL WUS. The UE may then transmit a PRACH to the network node, indicating a UL WUS that includes a request for a SIB, based on the PRACH configuration. Additionally, the PRACH configuration may relate to time-domain configurations associated with scheduling of PRACH occasions. In some aspects, the PRACH configuration may indicate a periodicity for PRACH resources based on an SSB periodicity associated with an initial cell selection for the UE or associated with a PRACH occasion validation associated with the request for the SIB. Additionally, in some aspects, the PRACH may be transmitted in one or more PRACH occasions determined by an offset applied to a reference frequency indicated by the PRACH configuration.

According to some examples described herein, the UE may utilize the PRACH configuration to request system information (e.g., SIB1) with increased efficiency, including a reduced signaling load. As a result, the UE may conserve processing and network resources, and may increase spectral efficiency. Furthermore, the UE's ability to adapt sub-carrier spacing (e.g., as indicated by the MIB) to match the PRACH format associated with the resource configuration may increase the efficiency of resource utilization. As a result, the UE may reduce power consumption and conserve processing resources by minimizing unnecessary frequency usage and reducing excessive energy usage (e.g., resulting from inappropriate format selection).

Additionally, the system's use of a single bit to indicate the generation of PRACH preambles based on restricted or unrestricted configurations may conserve memory resources and reduce signaling overhead. As a result, such a signaling technique may improve the efficiency of the SIB1 request process while retaining flexibility or robustness in the transmissions between the UE and the network node. In some aspects, the use of a reference frequency and one or more offsets for frequency-domain resource configurations may enable the UE to determine one or more frequency locations for PRACH occasions with minimal signaling, thereby conserving processing and network resources and reducing signaling complexity.

As indicated above, FIGS. 8A-8B are provided as an example. Other examples may differ from what is described with respect to FIGS. 8A-8B.

FIG. 9 is a diagram illustrating an example process 900 performed, for example, at a UE or an apparatus of a UE. Example process 900 is an example where the apparatus or the UE (e.g., UE 120) performs operations associated with UL WUS configurations.

As shown in FIG. 9, in some aspects, process 900 may include receiving, from a network node, an SSB (block 910). For example, the UE (e.g., using reception component 1102 or communication manager 1106, depicted in FIG. 11) may receive, from a network node, an SSB, as described above.

As further shown in FIG. 9, in some aspects, process 900 may include receiving, from the network node, a configuration message including a PRACH configuration associated with the PBCH of the SSB (block 920). For example, the UE (e.g., using reception component 1102 or communication manager 1106, depicted in FIG. 11) may receive, from the network node, a configuration message including a PRACH configuration associated with the PBCH of the SSB, as described above.

As further shown in FIG. 9, in some aspects, process 900 may include transmitting, to the network node, a PRACH as a UL WUS that includes a request for a SIB, wherein the PRACH is transmitted based on the PRACH configuration (block 930). For example, the UE (e.g., using transmission component 1104 or communication manager 1106, depicted in FIG. 11) may transmit, to the network node, a PRACH as a UL WUS that includes a request for a SIB, wherein the PRACH is transmitted based on the PRACH configuration, as described above.

Process 900 may include additional aspects, such as any single aspect or any combination of aspects described below or in connection with one or more other processes described elsewhere herein.

In a first aspect, the PRACH configuration is associated with a time-domain configuration.

In a second aspect, alone or in combination with the first aspect, the PRACH is associated with a PRACH preamble format associated with a bit configuration.

In a third aspect, alone or in combination with one or more of the first and second aspects, the PRACH configuration indicates scheduling of one or more PRACH occasions in SFNs associated with an odd value or with an even value.

In a fourth aspect, alone or in combination with one or more of the first through third aspects, the PRACH configuration indicates a periodicity for one or more PRACH resources associated with the time-domain configuration.

In a fifth aspect, alone or in combination with one or more of the first through fourth aspects, the time-domain configuration is associated with a periodicity for one or more PRACH resources, based on an SSB periodicity associated with an initial cell selection for the UE.

In a sixth aspect, alone or in combination with one or more of the first through fifth aspects, the time-domain configuration is associated with a periodicity for one or more PRACH resources, based on an SSB periodicity associated with a PRACH occasion validation associated with the request for the SIB.

In a seventh aspect, alone or in combination with one or more of the first through sixth aspects, the time-domain configuration is associated with a periodicity that is independent of an SSB periodicity associated with an initial cell selection for the UE and that is independent of an SSB periodicity associated with a PRACH occasion validation associated with one or more PRACH resources.

In an eighth aspect, alone or in combination with one or more of the first through seventh aspects, the PRACH is transmitted in one or more PRACH occasions determined by an offset applied to a reference frequency indicated by the PRACH configuration.

In a ninth aspect, alone or in combination with one or more of the first through eighth aspects, the reference frequency is associated with a smallest absolute radio frequency channel number of an uplink band.

In a tenth aspect, alone or in combination with one or more of the first through ninth aspects, the reference frequency is associated with an uplink band.

In an eleventh aspect, alone or in combination with one or more of the first through tenth aspects, the transmission of the PRACH utilizes a sub-carrier spacing configured for downlink channels in a master information block of the PBCH, based on the PRACH configuration indicating a short PRACH format.

In a twelfth aspect, alone or in combination with one or more of the first through eleventh aspects, the transmission of the PRACH utilizes a configured sub-carrier spacing, based on the PRACH configuration indicating a long PRACH format.

In a thirteenth aspect, alone or in combination with one or more of the first through twelfth aspects, the transmission of the PRACH utilizes a sub-carrier spacing indicated by a master information block in accordance with a PRACH format associated with the PRACH configuration.

In a fourteenth aspect, alone or in combination with one or more of the first through thirteenth aspects, the transmission of the PRACH utilizes a sub carrier spacing indicated by a master information block, based on the PRACH configuration indicating a short PRACH format, or wherein, the transmission of the PRACH utilizes a configured sub-carrier spacing based on the PRACH configuration indicating a long PRACH format.

In a fifteenth aspect, alone or in combination with one or more of the first through fourteenth aspects, the PRACH is associated with a PRACH preamble that is generated based on an unrestricted configuration, associated with a cyclic shift of a random access channel sequence, based on the PRACH configuration indicating a long PRACH format.

In a sixteenth aspect, alone or in combination with one or more of the first through fifteenth aspects, the PRACH is associated with a PRACH preamble that is generated based on an unrestricted configuration or a restricted configuration, associated with a cyclic shift of a random access channel sequence, in accordance with the PRACH configuration indicating a long PRACH format.

In a seventeenth aspect, alone or in combination with one or more of the first through sixteenth aspects, the PRACH configuration includes a single bit indicating whether the PRACH preamble is generated based on the unrestricted configuration or the restricted configuration.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node. Example process 1000 is an example where the apparatus or the network node (e.g., network node 110) performs operations associated with UL WUS configurations.

As shown in FIG. 10, in some aspects, process 1000 may include transmitting, to a UE, an SSB (block 1010). For example, the network node (e.g., using transmission component 1204 or communication manager 1206, depicted in FIG. 12) may transmit, to a UE, an SSB, as described above.

As further shown in FIG. 10, in some aspects, process 1000 may include transmitting, to the UE, a configuration message including a PRACH configuration associated with the PBCH of the SSB (block 1020). For example, the network node (e.g., using transmission component 1204 or communication manager 1206, depicted in FIG. 12) may transmit, to the UE, a configuration message including a PRACH configuration associated with the PBCH of the SSB, as described above.

As further shown in FIG. 10, in some aspects, process 1000 may include receiving, from the UE, a PRACH as a UL WUS that includes a request for a SIB (block 1030). For example, the network node (e.g., using reception component 1202 or communication manager 1206, depicted in FIG. 12) may receive, from the UE, a PRACH as a UL WUS that includes a request for a SIB, as described above.

Process 1000 may include additional aspects, such as any single aspect or any combination of aspects described below or in connection with one or more other processes described elsewhere herein.

In a first aspect, the PRACH configuration is associated with a time-domain configuration.

In a second aspect, alone or in combination with the first aspect, the PRACH is associated with a PRACH preamble format associated with a bit configuration.

In a third aspect, alone or in combination with one or more of the first and second aspects, the PRACH configuration indicates scheduling of one or more PRACH occasions in SFNs associated with an odd value or with an even value.

In a fourth aspect, alone or in combination with one or more of the first through third aspects, the PRACH configuration indicates a periodicity for one or more PRACH resources associated with the time-domain configuration.

In a fifth aspect, alone or in combination with one or more of the first through fourth aspects, the time-domain configuration is associated with a periodicity for one or more PRACH resources, based on an SSB periodicity associated with an initial cell selection for the UE.

In a sixth aspect, alone or in combination with one or more of the first through fifth aspects, the time-domain configuration is associated with a periodicity for one or more PRACH resources, based on an SSB periodicity associated with a PRACH occasion validation associated with the request for the SIB.

In a seventh aspect, alone or in combination with one or more of the first through sixth aspects, the time-domain configuration is associated with a periodicity that is independent of an SSB periodicity associated with an initial cell selection for the UE and that is independent of an SSB periodicity associated with a PRACH occasion validation associated with one or more PRACH resources.

In an eighth aspect, alone or in combination with one or more of the first through seventh aspects, the PRACH is associated with a sub-carrier spacing configured for downlink in a master information block.

In a ninth aspect, alone or in combination with one or more of the first through eighth aspects, the PRACH is associated with a sub-carrier spacing of 1.25 kilohertz.

In a tenth aspect, alone or in combination with one or more of the first through ninth aspects, the PRACH is associated with a sub-carrier spacing indicated by a master information block.

In an eleventh aspect, alone or in combination with one or more of the first through tenth aspects, the PRACH is associated with a PRACH preamble associated with an unrestricted configuration, for a cyclic shift of a random access channel sequence, in accordance with the PRACH configuration indicating a long PRACH format.

In a twelfth aspect, alone or in combination with one or more of the first through eleventh aspects, the PRACH configuration includes a single bit indicating whether a PRACH preamble, associated with the PRACH, is to be generated based on a restricted configuration or an unrestricted configuration, associated with a cyclic shift of a random access channel sequence, in accordance with the PRACH configuration indicating a long PRACH format.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 8A-8B. Additionally, or alternatively, the apparatus 1100 may be configured to perform one or more processes described herein, such as process 900 of FIG. 9. In some aspects, the apparatus 1100 or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The reception component 1102 may receive, from a network node, an SSB. The reception component 1102 may receive, from the network node, a configuration message including a PRACH configuration associated with the PBCH of the SSB. The transmission component 1104 may transmit, to the network node, a PRACH as a UL WUS that includes a request for a SIB, wherein the PRACH is transmitted based on the PRACH configuration.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network node, or a network node may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 8A-8B. Additionally, or alternatively, the apparatus 1200 may be configured to perform one or more processes described herein, such as process 1000 of FIG. 10. In some aspects, the apparatus 1200 or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 or the transmission component 1204 may include or may be included in a network interface. The network interface may be configured to obtain or output signals for the apparatus 1200 via one or more communications links, such as a backhaul link, a midhaul link, or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The transmission component 1204 may transmit, to a UE, an SSB. The transmission component 1204 may transmit, to the UE, a configuration message including a PRACH configuration associated with the PBCH of the SSB. The reception component 1202 may receive, from the UE, a PRACH as a UL WUS that includes a request for a SIB.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method for wireless communication performed by a user equipment (UE), comprising: receiving, from a network node, a synchronization signal (SS) and physical broadcast channel (PBCH) block (SSB); receiving, from the network node, a configuration message including a physical random access channel (PRACH) configuration associated with the PBCH of the SSB; and transmitting, to the network node, a PRACH as an uplink wake up signal (UL WUS) that includes a request for a system information block (SIB), wherein the PRACH is transmitted based on the PRACH configuration.
Aspect 2: The method of Aspect 1, wherein the PRACH configuration is associated with a time-domain configuration.
Aspect 3: The method of Aspect 2, wherein the PRACH is associated with a PRACH preamble format associated with a bit configuration.
Aspect 4: The method of Aspect 2, wherein the PRACH configuration indicates scheduling of one or more PRACH occasions in subframe numbers (SFNs) associated with an odd value or with an even value.
Aspect 5: The method of Aspect 2, wherein the PRACH configuration indicates a periodicity for one or more PRACH resources associated with the time-domain configuration.
Aspect 6: The method of Aspect 2, wherein the time-domain configuration is associated with a periodicity for one or more PRACH resources, based on an SSB periodicity associated with an initial cell selection for the UE.
Aspect 7: The method of Aspect 2, wherein the time-domain configuration is associated with a periodicity for one or more PRACH resources, based on an SSB periodicity associated with a PRACH occasion validation associated with the request for the SIB.
Aspect 8: The method of Aspect 2, wherein the time-domain configuration is associated with a periodicity that is independent of an SSB periodicity associated with an initial cell selection for the UE and that is independent of an SSB periodicity associated with a PRACH occasion validation associated with one or more PRACH resources.
Aspect 9: The method of any of Aspects 1-8, wherein the PRACH is transmitted in one or more PRACH occasions determined by an offset applied to a reference frequency indicated by the PRACH configuration.
Aspect 10: The method of Aspect 9, wherein the reference frequency is associated with a smallest absolute radio frequency channel number of an uplink band.
Aspect 11: The method of Aspect 9, wherein the reference frequency is associated with an uplink band.
Aspect 12: The method of any of Aspects 1-11, wherein the transmission of the PRACH utilizes a sub-carrier spacing configured for downlink channels in a master information block of the PBCH, based on the PRACH configuration indicating a short PRACH format.
Aspect 13: The method of any of Aspects 1-12, wherein the transmission of the PRACH utilizes a configured sub-carrier spacing, based on the PRACH configuration indicating a long PRACH format.
Aspect 14: The method of any of Aspects 1-13, wherein the transmission of the PRACH utilizes a sub-carrier spacing indicated by a master information block in accordance with a PRACH format associated with the PRACH configuration.
Aspect 15: The method of any of Aspects 1-14, wherein the transmission of the PRACH utilizes a sub carrier spacing indicated by a master information block, based on the PRACH configuration indicating a short PRACH format, or wherein, the transmission of the PRACH utilizes a configured sub-carrier spacing based on the PRACH configuration indicating a long PRACH format.
Aspect 16: The method of any of Aspects 1-15, wherein the PRACH is associated with a PRACH preamble that is generated based on an unrestricted configuration, associated with a cyclic shift of a random access channel sequence, based on the PRACH configuration indicating a long PRACH format.
Aspect 17: The method of any of Aspects 1-16, wherein the PRACH is associated with a PRACH preamble that is generated based on an unrestricted configuration or a restricted configuration, associated with a cyclic shift of a random access channel sequence, in accordance with the PRACH configuration indicating a long PRACH format.
Aspect 18: The method of Aspect 17, wherein the PRACH configuration includes a single bit indicating whether the PRACH preamble is generated based on the unrestricted configuration or the restricted configuration.
Aspect 19: A method of wireless communication performed by a network node, comprising: transmitting, to a user equipment (UE), a synchronization signal (SS) and physical broadcast channel (PBCH) block (SSB); transmitting, to the UE, a configuration message including a physical random access channel (PRACH) configuration associated with the PBCH of the SSB; and receiving, from the UE, a PRACH as an uplink wake up signal (UL WUS) that includes a request for a system information block (SIB).
Aspect 20: The method of Aspect 19, wherein the PRACH configuration is associated with a time-domain configuration.
Aspect 21: The method of Aspect 20, wherein the PRACH is associated with a PRACH preamble format associated with a bit configuration.
Aspect 22: The method of Aspect 20, wherein the PRACH configuration indicates scheduling of one or more PRACH occasions in subframe numbers (SFNs) associated with an odd value or with an even value.
Aspect 23: The method of Aspect 20, wherein the PRACH configuration indicates a periodicity for one or more PRACH resources associated with the time-domain configuration.
Aspect 24: The method of Aspect 20, wherein the time-domain configuration is associated with a periodicity for one or more PRACH resources, based on an SSB periodicity associated with an initial cell selection for the UE.
Aspect 25: The method of Aspect 20, wherein the time-domain configuration is associated with a periodicity for one or more PRACH resources, based on an SSB periodicity associated with a PRACH occasion validation associated with the request for the SIB.
Aspect 26: The method of Aspect 20, wherein the time-domain configuration is associated with a periodicity that is independent of an SSB periodicity associated with an initial cell selection for the UE and that is independent of an SSB periodicity associated with a PRACH occasion validation associated with one or more PRACH resources.
Aspect 27: The method of any of Aspects 19-26, wherein the PRACH is associated with a sub-carrier spacing configured for downlink in a master information block.
Aspect 28: The method of any of Aspects 19-27, wherein the PRACH is associated with a sub-carrier spacing of 1.25 kilohertz.
Aspect 29: The method of any of Aspects 19-28, wherein the PRACH is associated with a sub-carrier spacing indicated by a master information block.
Aspect 30: The method of any of Aspects 19-29, wherein the PRACH is associated with a PRACH preamble associated with an unrestricted configuration, for a cyclic shift of a random access channel sequence, in accordance with the PRACH configuration indicating a long PRACH format.
Aspect 31: The method of any of Aspects 19-30, wherein the PRACH configuration includes a single bit indicating whether a PRACH preamble, associated with the PRACH, is to be generated based on a restricted configuration or an unrestricted configuration, associated with a cyclic shift of a random access channel sequence, in accordance with the PRACH configuration indicating a long PRACH format.
Aspect 32: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-31.
Aspect 33: An apparatus for wireless communication at a device, the apparatus comprising one or more memories and one or more processors coupled to the one or more memories, the one or more processors configured to cause the device to perform the method of one or more of Aspects 1-31.
Aspect 34: An apparatus for wireless communication, the apparatus comprising at least one means for performing the method of one or more of Aspects 1-31.
Aspect 35: A non-transitory computer-readable medium storing code for wireless communication, the code comprising instructions executable by one or more processors to perform the method of one or more of Aspects 1-31.
Aspect 36: A non-transitory computer-readable medium storing a set of instructions for wireless communication, the set of instructions comprising one or more instructions that, when executed by one or more processors of a device, cause the device to perform the method of one or more of Aspects 1-31.
Aspect 37: A device for wireless communication, the device comprising a processing system that includes one or more processors and one or more memories coupled with the one or more processors, the processing system configured to cause the device to perform the method of one or more of Aspects 1-31.
Aspect 38: An apparatus for wireless communication at a device, the apparatus comprising one or more memories and one or more processors coupled to the one or more memories, the one or more processors individually or collectively configured to cause the device to perform the method of one or more of Aspects 1-31.
Aspect 39: A device comprising a processing system that includes one or more processors and one or more code-storing memories coupled with the one or more processors, the processing system configured to cause the device to perform the method of one or more of Aspects 1-31.
Aspect 40: A device comprising a processing system that includes processor circuitry and code-storing memory circuitry, the processing system configured to cause the device to perform the method of one or more of Aspects 1-31.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, a synchronization signal (SS) and physical broadcast channel (PBCH) block (SSB);
receive, from the network node, a configuration message including a physical random access channel (PRACH) configuration associated with the PBCH of the SSB; and
transmit, to the network node, a PRACH as an uplink wake up signal (UL WUS) that includes a request for a system information block (SIB), wherein the PRACH is transmitted based on the PRACH configuration.

2. The UE of claim 1, wherein the PRACH configuration is associated with a time-domain configuration.

3. The UE of claim 2, wherein the PRACH is associated with a PRACH preamble format associated with a bit configuration.

4. The UE of claim 2, wherein the PRACH configuration indicates scheduling of one or more PRACH occasions in subframe numbers (SFNs) associated with an odd value or with an even value.

5. The UE of claim 2, wherein the PRACH configuration indicates a periodicity for one or more PRACH resources associated with the time-domain configuration.

6. The UE of claim 1, wherein the PRACH is transmitted in one or more PRACH occasions determined by an offset applied to a reference frequency indicated by the PRACH configuration.

7. The UE of claim 1, wherein the transmission of the PRACH utilizes a sub-carrier spacing configured for downlink channels in a master information block of the PBCH, based on the PRACH configuration indicating a short PRACH format.

8. The UE of claim 1, wherein the transmission of the PRACH utilizes a configured sub-carrier spacing, based on the PRACH configuration indicating a long PRACH format.

9. The UE of claim 1, wherein the transmission of the PRACH utilizes a sub-carrier spacing indicated by a master information block in accordance with a PRACH format associated with the PRACH configuration.

10. The UE of claim 1, wherein the transmission of the PRACH utilizes a sub carrier spacing indicated by a master information block, based on the PRACH configuration indicating a short PRACH format, or
wherein, the transmission of the PRACH utilizes a configured sub-carrier spacing based on the PRACH configuration indicating a long PRACH format.

11. The UE of claim 1, wherein the PRACH is associated with a PRACH preamble that is generated based on an unrestricted configuration, associated with a cyclic shift of a random access channel sequence, based on the PRACH configuration indicating a long PRACH format.

12. The UE of claim 1, wherein the PRACH is associated with a PRACH preamble that is generated based on an unrestricted configuration or a restricted configuration, associated with a cyclic shift of a random access channel sequence, in accordance with the PRACH configuration indicating a long PRACH format.

13. A network node, comprising:
a processing system that includes one or more processors and one or more code-storing memories coupled with the one or more processors, the processing system configured to cause the network node to:
transmit, to a user equipment (UE), a synchronization signal (SS) and physical broadcast channel (PBCH) block (SSB);
transmit, to the UE, a configuration message including a physical random access channel (PRACH) configuration associated with the PBCH of the SSB; and
receive, from the UE, a PRACH as an uplink wake up signal (UL WUS) that includes a request for a system information block (SIB).

14. The network node of claim 13, wherein the PRACH configuration is associated with a time-domain configuration.

15. The network node of claim 13, wherein the PRACH is associated with a sub-carrier spacing configured for downlink in a master information block.

16. The network node of claim 13, wherein the PRACH is associated with a sub-carrier spacing of 1.25 kilohertz.

17. The network node of claim 13, wherein the PRACH is associated with a sub-carrier spacing indicated by a master information block.

18. The network node of claim 13, wherein the PRACH is associated with a PRACH preamble associated with an unrestricted configuration, for a cyclic shift of a random access channel sequence, in accordance with the PRACH configuration indicating a long PRACH format.

19. The network node of claim 13, wherein the PRACH configuration includes a single bit indicating whether a PRACH preamble, associated with the PRACH, is to be generated based on a restricted configuration or an unrestricted configuration, associated with a cyclic shift of a random access channel sequence, in accordance with the PRACH configuration indicating a long PRACH format.

20. A method for wireless communication performed by a user equipment (UE), comprising:
receiving, from a network node, a synchronization signal (SS) and physical broadcast channel (PBCH) block (SSB);
receiving, from the network node, a configuration message including a physical random access channel (PRACH) configuration associated with the PBCH of the SSB; and
transmitting, to the network node, a PRACH as an uplink wake up signal (UL WUS) that includes a request for a system information block (SIB), wherein the PRACH is transmitted based on the PRACH configuration.
